(19) United States
(12) Patent Application Publication
(10) Pub. No.: US 2010/0265241 A1
(43) Pub. Date: Oct. 21, 2010

(54) Display apparatus using power supply circuit

(75) Inventor: Takashi Tahata, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/662,458

(22) Filed: Apr. 19, 2010

(30) Foreign Application Priority Data
Apr. 21, 2009 (JP) 2009-102873

(51) Int. Cl. G09G 5/00

(52) U.S. Cl. 345/212

(57) ABSTRACT

A power supply circuit for a display apparatus, includes: a voltage boosting circuit configured to boost up an input voltage based on a voltage boosting factor to output a boosted output voltage; a voltage detecting circuit configured to compare a voltage level of a power supply voltage to which the input voltage is related and a predetermined voltage level; and a control circuit configured to output one of a first voltage boosting factor and a second voltage boosting factor as the voltage boosting factor to the voltage boosting circuit based on the comparison result. The control circuit changes the voltage boosting factor during a blanking period in a display panel.

### INCORPORATION BY REFERENCE

This application claims a priority on convention based on Japanese Patent Application No. 2009-102873. The disclosure thereof is incorporated herein by reference.

### TECHNICAL FIELD

The present invention generally relates to a display apparatus, a power supply circuit for the same, and a changing method of a voltage boosting factor of a power supply voltage for the display apparatus.

### BACKGROUND ART

In recent years, in a mobile terminal such as a cellular phone and a mobile computer, a battery is generally used as a power supply. Therefore, a power saving of the mobile terminal is desired to be achieved. In particular, since a consumed power of display apparatus mounted on the mobile terminal occupies a major rate of the consumed power of the whole terminal, it is effective for the power saving of the mobile terminal to reduce the consumed power of the display apparatus. In order to reduce the consumed power of the display apparatus, it is necessary to change (or select) a power supply voltage to be supplied to the display apparatus in accordance with a battery voltage so as to minimize a consumption current in a power supply circuit. For example, Patent Literature 1 (Japanese Patent Publication: JP 2005-080395A) discloses a conventional power supply circuit provided with a charge pump circuit in which a voltage boosting factor or a voltage boosting factor is changed according to a battery voltage.

The conventional power supply circuit for a display apparatus will be described below with reference to FIGS. 1 and 2. FIG. 1 is a circuit diagram showing a configuration of the conventional power supply circuit 201. Referring to FIG. 1, the conventional power supply circuit 201 includes a charge pump circuit 202, a display panel driving voltage generating regulator 203 (to be referred to as a “regulator 203”, hereinafter), a voltage detecting circuit 204, an input voltage generating regulator 205 (to be referred to as a “regulator 205”, hereinafter) and a comparing circuit 206.

In the power supply circuit 201, the charge pump circuit 202 boosts a voltage supplied from a battery (to be referred to as a “battery voltage VBAT”, hereinafter) so that the boosted voltage is outputted as an output voltage VOUT. The regulator 203 receives the boosted voltage VOUT as a power supply voltage thereof and generates a display panel driving voltage VPNL. The voltage detecting circuit 204 generates a control signal DET based on the output voltage VOUT and the display panel driving voltage VPNL in order to keep the output voltage VOUT constant. The regulator 205 generates an input voltage VIN to be applied to the charge pump circuit 202 by using the battery voltage VBAT as a power supply voltage thereof. At this time, the regulator 205 defines the input voltage VIN based on a voltage changed or selected in accordance with the control signal DET. The comparing circuit 206 compares the battery voltage VBAT with a reference voltage VREF and outputs a comparison result as a voltage boosting factor setting signal BT to be supplied to the charge pump circuit 202. The charge pump circuit 202 changes the voltage boosting factor in accordance with the voltage boosting factor setting signal BT.

By the configuration as mentioned above, in the conventional power supply circuit, the voltage boosting factor of the output voltage VOUT is changed in accordance with the comparison result between the battery voltage VBAT and the reference voltage VREF (i.e., based on the voltage boosting factor setting signal BT).

First, referring to FIG. 2, an operation of the charge pump circuit 202 will be described. FIG. 2 is a circuit diagram showing a configuration of the conventional charge pump circuit 202. The charge pump circuit 202 includes switches SW1 to SW9 that are controlled in accordance with the voltage boosting factor setting signal BT. The switches SW1 to SW4 control the connections between the terminal to which the input voltage VIN is supplied (to be referred to as “VIN terminal”, hereinafter”) and pumping capacitors. The switches SW5 and SW6 control the connections between the terminal from which the output voltage VOUT is outputted (to be referred to as “VOUT terminal”, hereinafter) and the pumping capacitors. The switch SW7 controls the connection between the pumping capacitors C1 and C2. The switches SW8 and SW9 control the connections between the grounded GND terminal and the pumping capacitors.

Specifically, the charge pump circuit 202 has terminals C1+ and C1− which are connected to the pumping capacitor C1 and terminals C2+ and C2− which are connected to the pumping capacitor C2. The switch SW1 is connected between the VIN terminal and the terminal C2−. The switch SW2 is connected between the VIN terminal and the terminal C2+. The switch SW3 is connected between the VIN terminal and the terminal C1−. The switch SW4 is connected between the VIN terminal and the terminal C1+. The switch SW5 is connected between the VOUT terminal and the terminal C2+. The switch SW6 is connected between the VOUT terminal and the terminal C1+. The switch SW7 is connected between the terminal C1− and the terminal C2+. The switch SW8 is connected between the terminal C2− and a ground (GND) terminal. The switch SW9 is connected between the terminal C1− and the GND terminal.

By this arrangement, the charge pump circuit 202 controls the switches SW1 to SW9 in accordance with the voltage boosting factor setting signal BT and changes the connection state of the pumping capacitors to discharge, thereby changing the voltage boosting factor of the output voltage VOUT. For example, when the input voltage VIN is boosted (or multiplied) by the voltage boosting factor of 2, the control of the switches SW1 to SW9 is executed in response to the voltage boosting factor setting signal BT, whereby a first charging state in which the pumping capacitors C1 and C2 are charged and a first discharging state in which the pumping capacitors C1 and C2 are discharged are repeated. Thus, the charge pump circuit 202 outputs the output voltage VOUT that is two times of the input voltage VIN.

In specific, at a first timing, the switches SW2, SW4, SW8 and SW9 are turned on and the other switches SW1, SW3, SW5, SW6 and SW7 are turned off (i.e., the first charging state). Thus, the two pumping capacitors C1 and C2 are connected in parallel between the VIN terminal and the GND terminal, and the two pumping capacitors C1 and C2 are charged to the input voltage VIN. As a result, the input voltage VIN is applied between the terminals of each of the two pumping capacitors C1 and C2 (i.e., between the terminals C1+ and C1−, and between the terminals C2+ and C2−), respectively.

At a second timing when a preset time period has lapsed after the first charging state, the switches SW1, SW3, SW5 and SW6 are turned on and the other switches SW2, SW4, SW7, SW8 and SW9 are turned off (i.e., the first discharging state). Thus, the two pumping capacitors C1 and C2 are discharged in a state of being connected in parallel between the VIN terminal and the VOUT terminal. As a result, the charge pump circuit 202 outputs the output voltage VOUT having 2 times of the input voltage VIN.

Further, when the input voltage VIN is multiplied by the voltage boosting factor of 3, the control of the switches SW1 to SW9 is executed in response to the voltage boosting factor setting signal BT, whereby a second charging state of the pumping capacitors C1 and C2 and the second discharging state of the pumping capacitors C1 and C2 are repeated. Thus, the charge pump circuit 202 outputs the output voltage VOUT having a value obtained by multiplying the input voltage VIN by the voltage boosting factor of 3.

In specific, at a third timing, the switches SW2, SW4, SW8 and SW9 are turned on and the other switches SW1, SW3, SW5, SW6 and SW7 are turned off (i.e., the second charging state). Thus, the two pumping capacitors C1 and C2 are connected in parallel between the VIN terminal and the GND terminal, and the two pumping capacitors C1 and C2 are charged to the input voltage VIN. As a result, the input voltage VIN is applied between the terminals of each of the two pumping capacitors C1 and C2 (i.e., between the terminals C1+ and C1−, and between the terminals C2+ and C2−).

At a fourth timing when a preset time period has lapsed after the first charging state, the switches SW1, SW6 and SW7 are turned on and the other switches SW2, SW3, SW4, SW5, SW8 and SW9 are turned off (i.e., the second discharging state). Thus, the two pumping capacitors C1 and C2 are connected in series between the VIN terminal and the VOUT terminal. As a result, the charge pump circuit 202 outputs the output voltage VOUT having 3 times of the input voltage VIN.

The detecting circuit 204 controls the regulator 205 to keep the output voltage VOUT of the charge pump circuit 202 constant. That is, when multiplying the input voltage by the voltage boosting factor of 2, the two pumping capacitors C1 and C2 are charged with VIN (=VOUT/2), respectively, where VIN is the input voltage VIN and VOUT is the output voltage VOUT. On the other hand, when multiplying the input voltage by the voltage boosting factor of 3, the two pumping capacitors C1 and C2 are charged with VIN (=VOUT/3), respectively. Namely, the charging voltage of the pumping capacitors C1 and C2 are different before and after the voltage boosting factor is changed. Degradation of display quality occurs due to this voltage difference, and backward current flows toward a battery to destroy the battery.

For example, when the battery voltage VBAT is lowered during a multiplying (boosting) operation by the voltage boosting factor of 2, the comparing circuit 206 outputs the voltage boosting factor setting signal BT for the multiplying operation by the voltage boosting factor of 3 to the charge pump circuit 202. In this case, the charge corresponding to (VOUT/2 VOUT/3) reversely flows toward the battery via the regulator 205. The battery will be destroyed due to this backward current unless a protection circuit is provided for the battery.

If the voltage boosting factor is changed during the boosting operation, the output voltage VOUT of the charge pump circuit 202 is boosted up to 3/2 VOUT at a maximum. In this case, the regulator 203 using the output voltage VOUT as the power supply may be possibly destroyed.

Further, when the battery voltage VBAT is raised during the multiplying operation by the voltage boosting factor of 3, the comparing circuit 206 outputs the voltage boosting factor setting signal BT representing the multiplying operation state by the voltage boosting factor of 2 to the charge pump circuit 202. In this case, the multiplying operation by the voltage boosting factor of 2 is started in the state that the two pumping capacitors C1 and C2 have been charged with the input voltage VIN (=VOUT/3). That is, the output voltage VOUT is lowered to ⅔ VOUT at a lowest until the regulator 205 charges the pumping capacitors C1 and C2 with the voltage of VIN (=VOUT/2). Referring to FIG. 3, if the change of this state (i.e., change of the voltage boosting factor) is performed during the displaying period of a display panel (e.g., at a time T1), the display panel driving voltage VPNL outputted from the regulator 203 is lowered in accordance with the lowered output voltage VOUT of the charge pump circuit 202. Since the display panel driving voltage VPNL is a voltage for driving the display panel, there occurs an abnormality in display during a period the display panel driving voltage VPNL being lowered.

### CITATION LIST

Patent Literature 1; JP 2005-080395A

### SUMMARY OF THE INVENTION

In an aspect of the present invention, a power supply circuit for a display apparatus, includes: a voltage boosting circuit configured to boost up an input voltage based on a voltage boosting factor to output a boosted output voltage; a voltage detecting circuit configured to compare a voltage level of a power supply voltage to which the input voltage is related and a predetermined voltage level; and a control circuit configured to output one of a first voltage boosting factor and a second voltage boosting factor as the voltage boosting factor to the voltage boosting circuit based on the comparison result. The control circuit changes the voltage boosting factor during a blanking period in a display panel.

In another aspect of the present invention, a voltage boosting method for a display apparatus, is achieved by comparing a voltage level of a power supply voltage and a predetermined voltage level; by generating one of a first voltage boosting factor and a second voltage boosting factor as a voltage boosting factor based on the comparison result during a blanking period in a display panel; and by boosting up an input voltage related to the power supply voltage in response to the voltage boosting factor to output a boosted output voltage.

In still another aspect of the present invention, a display apparatus includes: a display panel; and a power supply circuit. The power supply circuit includes: a voltage boosting circuit configured to boost up an input voltage based on a voltage boosting factor to output a boosted output voltage; a voltage detecting circuit configured to compare a voltage level of a power supply voltage to which the input voltage is related and a predetermined voltage level; and a control circuit configured to output one of a first voltage boosting factor and a second voltage boosting factor as the voltage boosting factor to the voltage boosting circuit based on the comparison result. The control circuit changes the voltage boosting factor during a blanking period in the display panel.

According to the present invention, it becomes possible to prevent degradation of display quality when the voltage boosting factor of the display application power supply voltage is changed.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a circuit diagram showing a configuration of a conventional power supply circuit;

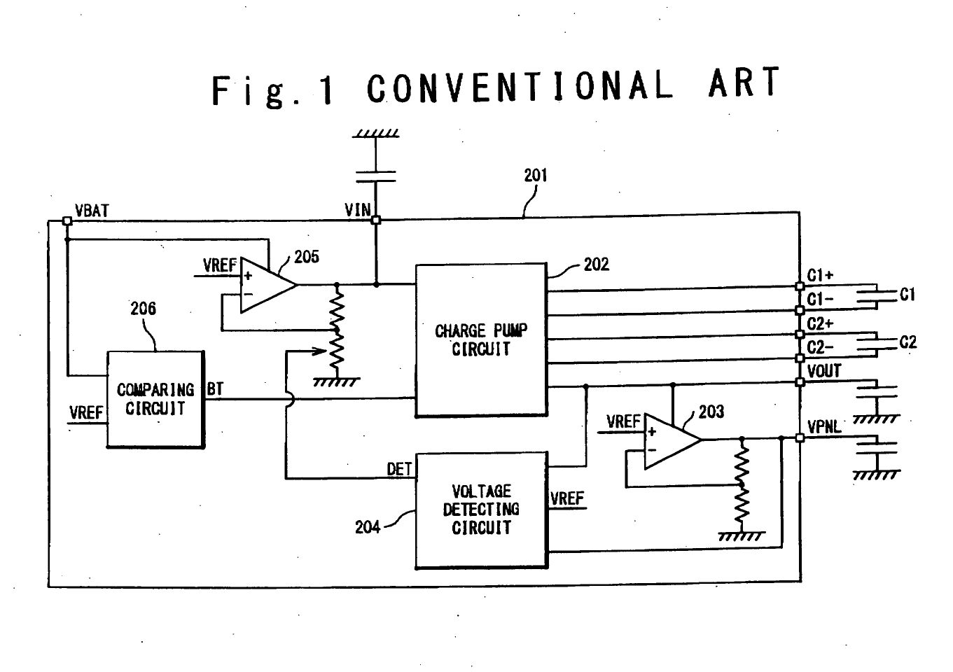

FIG. 2 is a circuit diagram showing a configuration of a conventional charge pump circuit;

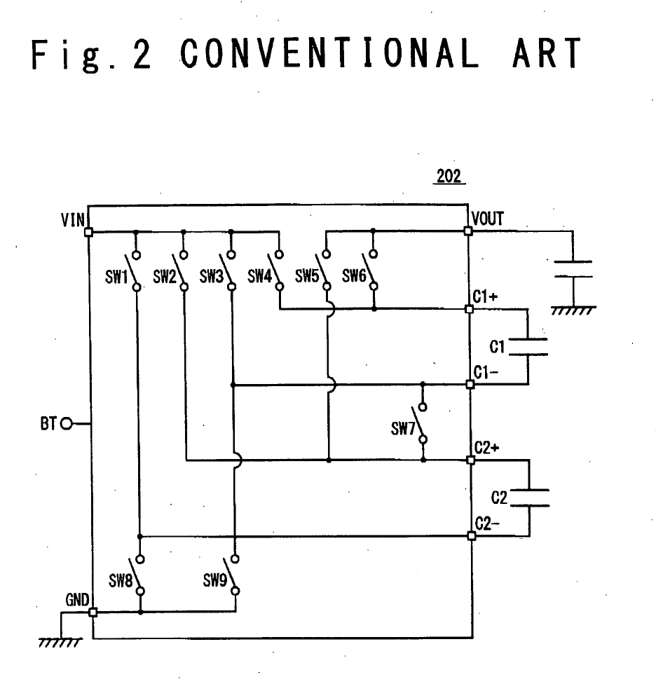

FIG. 3 is a timing chart showing an example of a conventional switching operation of a step-up rate of a power supply circuit;

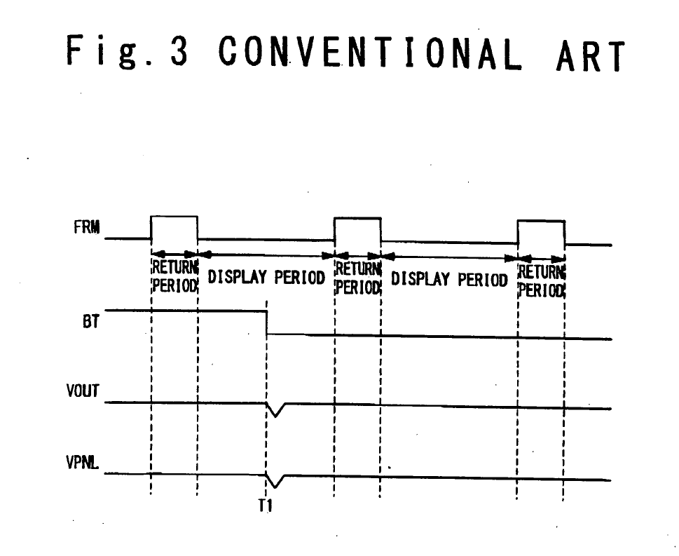

FIG. 4 is a block diagram showing a configuration of a display apparatus according to the present invention;

FIG. 5 is a circuit diagram showing a configuration of a power supply circuit according to the present invention;

FIG. 6 is a circuit diagram showing a configuration of a charge pump circuit according to the present invention;

FIG. 7 is a circuit diagram showing a first charging state of a power supply circuit according to the present invention;

FIG. 8 is a circuit diagram showing a first discharging state of a power supply circuit according to the present invention;

FIG. 9 is a circuit diagram showing a second charging state of a power supply circuit according to the present invention;

FIG. 10 is a circuit diagram showing a second discharging state of a power supply circuit according to the present invention;

FIG. 11 is a timing chart showing an example of a switching operation of a step-up rate to a higher voltage side of a power supply circuit according to the present invention;

FIG. 12 is a circuit diagram showing a third discharging state of a power supply circuit according to the present invention; and

FIG. 13 is a timing chart showing an example of a switching operation of a step-up rate to a lower voltage side of a power supply circuit according to the present invention.

### DESCRIPTION OF THE EMBODIMENTS

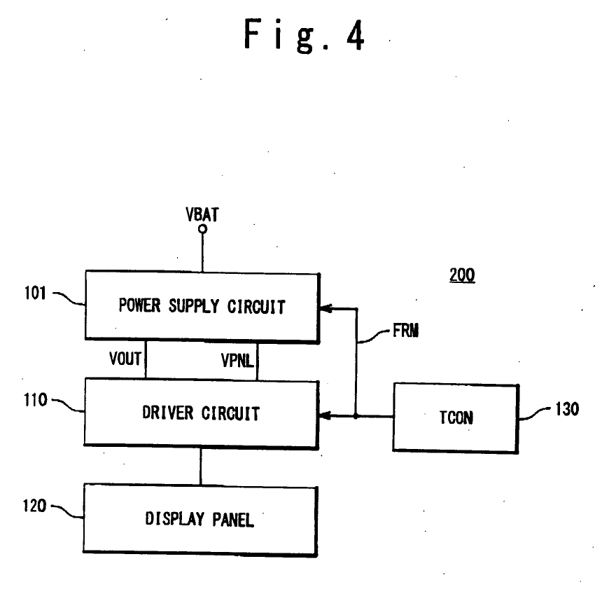

Hereinafter, a power supply circuit for a display apparatus according to the present invention will be described in detail with reference to the attached drawings. FIG. 4 is a block diagram showing a configuration of a display apparatus 200 of an embodiment according to the present invention. The display apparatus 200 according to the present invention is provided with a power supply circuit 101 for a display apparatus that changes a voltage boosting factor in accordance with a power supply voltage in order to minimize a consumed current. In the present embodiment, the display apparatus 200 which includes the power supply circuit 101 multiplying a power supply voltage directly supplied from a battery by the voltage boosting factor of 2 or 3, will be described as an example.

### (Configuration)

The display apparatus 200 according to the present invention includes the power supply circuit 101, a driver 110, a display panel 120 and a timing controller (TCON) 130. The power supply circuit 101 outputs an output voltage VOUT and a display panel driving voltage VPNL to the display driver 110 in accordance with a power supply voltage VBAT supplied from a battery (not shown). The driver 110 operates with the output voltage VOUT as a power supply voltage thereof and generates gray-scale voltages in accordance with the display panel driving voltage VPNL to drive the display panel 120. The display panel 120, exemplified by a liquid crystal panel, includes a plurality of pixels (not shown) driven with the gray-scale voltages supplied from the driver 110. The timing controller 130 outputs a timing pulse signal required for driving the display panel 120. The timing pulse signal includes a vertical synchronization signal, a horizontal synchronization signal, a frame signal FRM determining a blanking period in a horizontal synchronization period or a vertical synchronization period, and so forth. The driver 110 drives the display panel at timing based on the timing pulse. Further, the power supply circuit 101 according to the present invention performs a multiplying operation during the blanking period in accordance with the frame signal FRM.

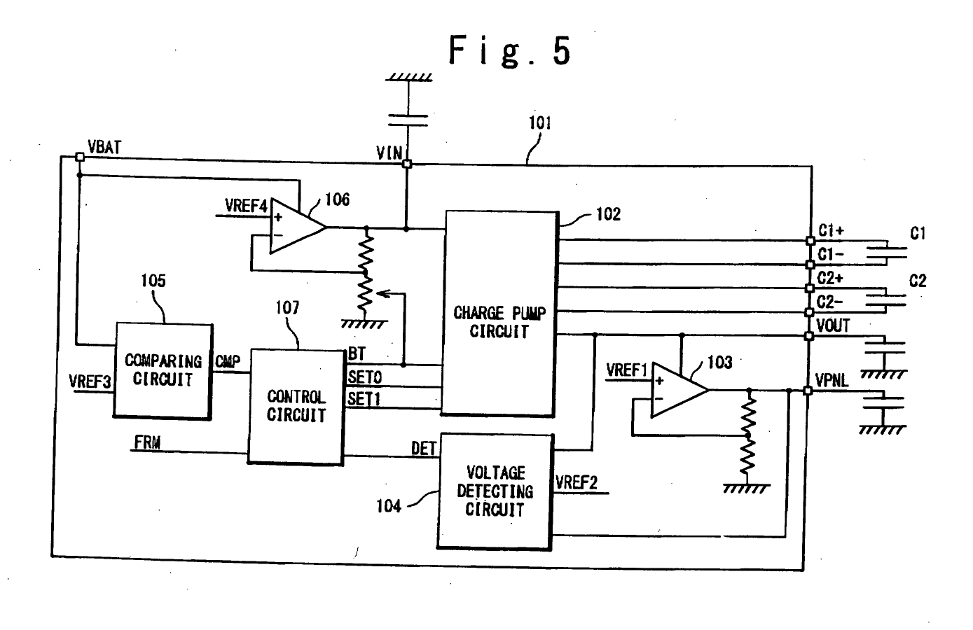

FIG. 5 is a circuit diagram showing configuration of the power supply circuit 101 according to the present invention. As shown in FIG. 5, the power supply circuit 101 according to the present invention includes a charge pump circuit (i.e., a voltage boosting circuit) 102, a display panel driving voltage generating regulator 103 (to be referred to as a “regulator 103”, hereinafter), a voltage detecting circuit 104, a comparing circuit (i.e., input voltage detecting circuit) 105, an input voltage generating regulator 106 (to be referred to as a “regulator 106”, hereinafter), and a control circuit (i.e., a voltage boosting control circuit) 107.

In the power supply circuit 101, the battery voltage VBAT is boosted up by the charge pump circuit 102 and the boosted voltage is outputted as the output voltage VOUT. The regulator 103 generates the display panel driving voltage VPNL by using the output voltage VOUT as a power supply voltage thereof. Specifically, the regulator 103 compares a result of dividing the display panel driving voltage VPNL by resistors and a reference voltage VREF1 and outputs the comparison result thereof as the display panel driving voltage VPNL. It should be noted that each of terminals for outputting the output voltage VOUT and the display panel driving voltage VPNL is connected with a stabilizing capacitor.

The voltage detecting circuit 104 generates a control signal (detection signal) DET for keeping the output voltage VOUT constant based on the output voltage VOUT and the display panel driving voltage VPNL. Specifically, the voltage detecting circuit 104 compares the output voltage VOUT and the reference voltage VREF2 or display panel driving voltage VPNL to detect variations in the output voltage VOUT and the display panel driving voltage VPNL. The detection signal DET based on the detection result is outputted to the control circuit 107. At this time, the voltage detecting circuit 104 determines a comparison object to be compared with the output voltage VOUT in accordance with a voltage boosting factor. For example, when multiplying by the voltage boosting factor of 2, the voltage detecting circuit 104 compares the output signal VOUT to the display panel driving voltage VPNL, and outputs the detection signal DET of a high level when VOUT≧VPNL, and outputs the detection signal DET of a low level when VOUT<VPNL, where VOUT is the output voltage and VPNL is the display panel driving voltage. Alternatively, when multiplying by the voltage boosting factor of 3, the voltage detecting circuit 104 compares the output signal VOUT with the reference voltage VREF2, and outputs the detection signal DET of the high level when VOUT≧VREF2, and outputs the detection signal DET of the low level when VOUT<VREF2, where VREF2 is the reference voltage. The detection signal DET is supplied to the control circuit 107 as data representing an optimum voltage boosting factor determined in accordance with the variations in the output voltage VOUT.

The comparing circuit 105 compares the battery voltage VBAT with a reference voltage VREF3 and outputs the comparison result thereof as a comparison result signal CMP, which is supplied to the control circuit 107. For example, the comparing circuit 105 outputs the comparison result signal CMP of the high level when VBAT≧VREF3, and outputs the comparison result signal CMP of the low level when VBAT<VREF3. The comparison result signal CMP is supplied to the control circuit 107 as a data representing the optimum voltage boosting factor determined in accordance with the variations in the battery voltage VBAT.

The control circuit 107 outputs the voltage boosting factor setting signal BT in synchronization with the frame signal FRM in accordance with the detection signal DET and the comparison result signal CMP. Specifically, the control circuit 107 detects variations in the output voltage VOUT and the display panel driving voltage VPNL based on the detection signal DET. For example, the control circuit 107 outputs the voltage boosting factor setting signal BT in the high level for increasing the voltage boosting factor in accordance with the detection signal DET of the high level, and outputs the voltage boosting factor setting signal BT in the low level for decreasing the voltage boosting factor in accordance with the detection signal DET of the low level. Further, the control circuit 107 detects variations in the battery voltage VBAT based on the comparison result signal CMP. The control circuit 107 outputs the voltage boosting factor setting signal BT in the high level for increasing the voltage boosting factor when the battery voltage VBAT decreased below the reference voltage VREF3, and oppositely outputs the voltage boosting factor setting signal BT in the low level for decreasing the voltage boosting factor when the battery voltage VBAT is increased beyond the reference voltage VREF3. Here, it is preferable that the signal level of the voltage boosting factor setting signal BT is changed in synchronization with the frame signal FRM.

Moreover, the control circuit 107 outputs voltage boosting factor switching preparation signals SET0 and SET1 (to be referred to as “preparation signals SET0 and SET1”, hereinafter) to the charge pump circuit 102 in synchronization with the frame signal FRM in accordance with the detection signal DET and the comparison result signal CMP. The preparation signal SET0 is outputted at the time of switching the voltage boosting factor to control the discharge of pumping capacitors used in the multiplying operation. The preparation signal SET1 is outputted after the discharging operation in response to the preparation signal SET0 or at a time of switching the voltage boosting factor, to control the charge of the pumping capacitors.

The regulator 106 generates an input voltage VIN to the charge pump circuit 102 by use of the battery voltage VBAT as the power supply voltage. At this time, the regulator 106 determines the input voltage VIN based on the comparison result between a voltage varied in accordance with the detection signal DET and the reference voltage REF4. For example, the control circuit 107 outputs the voltage boosting factor setting signal BT in the high level in accordance with the detection signal DET in the high level and the comparison result signal CMP. Thus, the input voltage VIN is set to VIN=VOUT/2 (where “VIN” is the input voltage). That is, when VOUT≧VPNL and VBAT≧VREF3 in a case of the multiplying operation by the voltage boosting factor of 2, or when VOUT≧VREF2 and VBAT≧VREF3 in a case of a multiplying operation by the voltage boosting factor of 3, the input voltage VIN is set to VIN=VOUT/2. Further, the control circuit 107 outputs the voltage boosting factor setting signal BT in the low level in accordance with the detection signal DET in the low level and the comparison result signal CMP. Thus, the input voltage VIN is set to VIN=VOUT/3. That is, when VOUT<VPNL and VBAT<VREF3 in the case of the multiplying operation by the voltage boosting factor of 3, or when VOUT<VREF2 and VBAT<VREF3 in the case of the multiplying operation by the voltage boosting factor of 3, the input voltage VIN is set to VIN=VOUT/3. It should be noted that the terminal to which the input voltage VIN is applied is connected to a stabilizing capacitor.

The charge pump circuit 102 is connected to a plurality of pumping capacitors (two pumping capacitors C1 and C2 in this example) and boosts the input voltage VIN by use of charge and discharge of the pumping capacitors to output as the output voltage VOUT. At this time, the charge pump circuit 102 switches the voltage boosting factor in accordance with the voltage boosting factor setting signal BT that is outputted in synchronization with the frame signal FRM. Specifically, the signal level of the voltage boosting factor setting signal BT changes in synchronization with the frame signal FRM. The voltage boosting factor of the charge pump circuit 102 is set to the voltage boosting factor of 2 while the voltage boosting factor setting signal BT is in the low level, and is set to the voltage boosting factor of 3 while the voltage boosting factor setting signal BT is in the high level. Therefore, the voltage boosting factor is switched to the higher voltage side (i.e., voltage boosting factor of 3) in response to the rising edge of the voltage boosting factor setting signal BT, and is switched to the lower voltage side (i.e., voltage boosting factor of 2) in response to a falling edge of the voltage boosting factor setting signal BT. In the charge pump circuit 102 according to the present invention, the pump circuit is charged and discharged in response to the preparation signals SET0 and SET1 before the voltage boosting factor is switched.

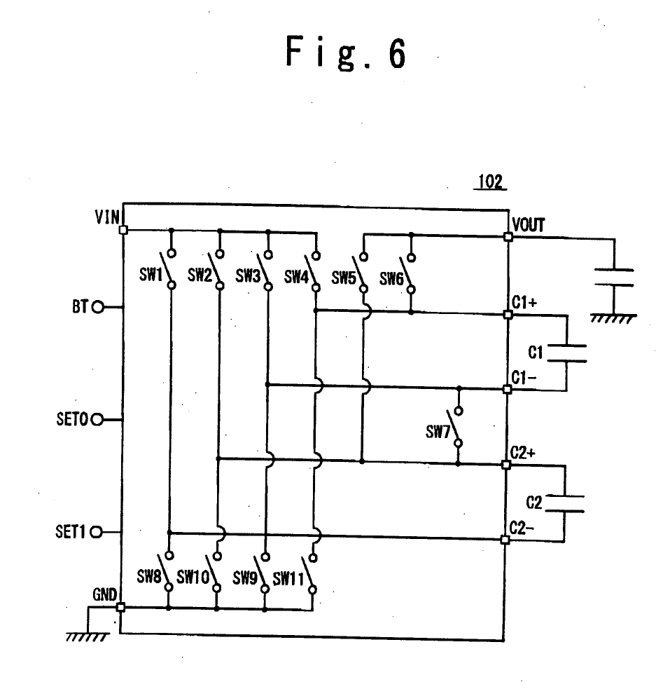

Next, the configuration of the charge pump circuit 102 will be described in details with reference to FIG. 6. As shown in FIG. 6, the charge pump circuit 102 is provided with switches SW1 to SW11 which are controlled in accordance with the voltage boosting factor setting signal BT and the preparation signals SET0 and SET1. The switches SW1 to SW4 control the connection between the terminals receiving the input voltage VIN (to be referred to as a “VIN terminal”, hereinafter) and the pumping capacitors. The switches SW5 and SW6 control the connection between the terminals outputting the output voltage VOUT (to be referred to as a “VOUT terminal” hereinafter) and the pumping capacitors. The switch SW7 controls the connection between the pumping capacitors C1 and C2. The switches SW8 to SW11 control the connection between the grounded GND terminal and the pumping capacitors.

Specifically, the charge pump circuit 102 has two pairs of terminals C1+ and C1−; and C2+ and C2−. The terminals C1+ and C1− are connected to the pumping capacitor C1 and the terminals C2+ and C2− are connected to the pumping capacitor C2. The switch SW1 is connected between the VIN terminal and the terminal C2−. The switch SW2 is connected between the VIN terminal and the terminal C2+. The switch SW3 is connected between the VIN terminal and the terminal C1−. The switch SW4 is connected between the VIN terminal and the terminal C1+. The switch SW5 is connected between the VOUT terminal and the terminal C2+. The switch SW6 is connected between the VOUT terminal and the terminal C1+. The switch SW7 is connected between the terminal C1− and the terminal C2+. The switch SW8 is connected between the terminal C2− and the GND terminal. The switch SW9 is connected between the terminal C1− and the GND terminal. The switch SW10 is connected between the terminal C2+ and the GND terminal. The switch SW11 is connected between the terminal C1+ and the GND terminal.

By this arrangement, the charge pump circuit 102 controls the switches SW1 to SW11 in accordance with the voltage boosting factor setting signal BT and changes the connection state of the pumping capacitors, thereby changing the voltage boosting factor for the output voltage VOUT.

### (Operation)

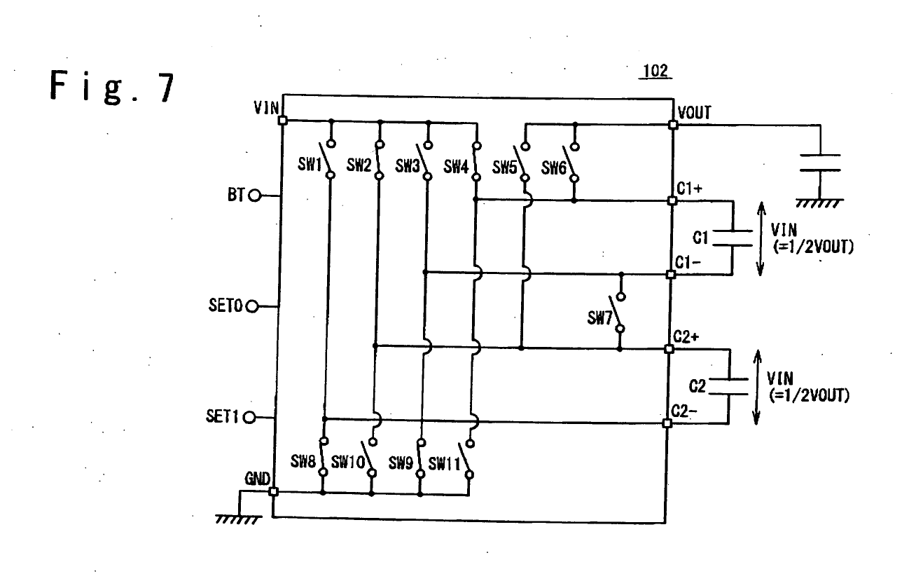

The boosting operation and switching operation of the voltage boosting factor of the power supply circuit 101 according to the present invention will be described in details with reference to FIGS. 7 to 13. First, the operation when multiplying by the voltage boosting factor of 2 and by the voltage boosting factor of 3 will be described.

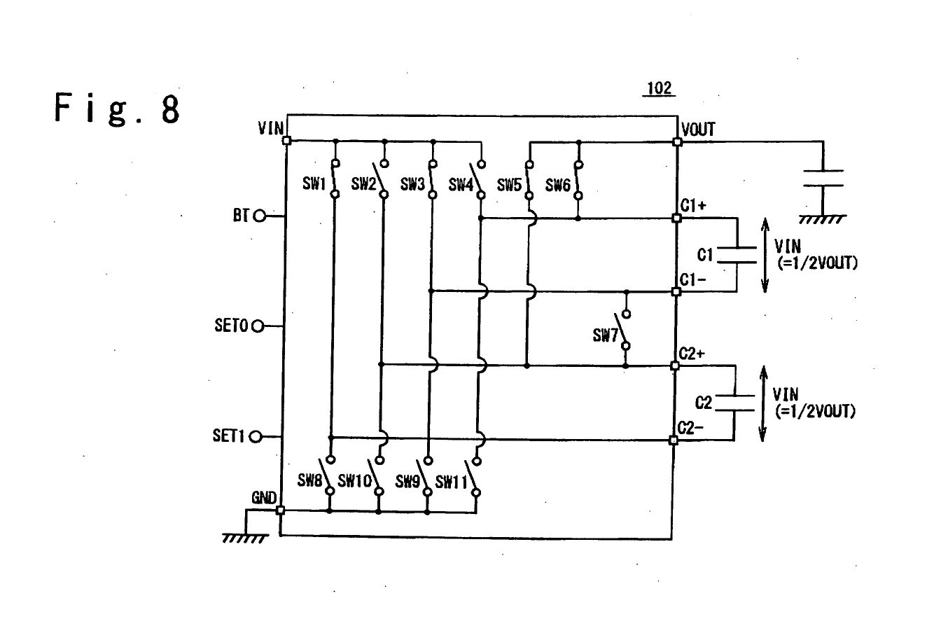

When the input voltage VIN is multiplied (or boosted) by the voltage boosting factor of 2, the control of the switches SW1 to SW11 is executed based on the voltage boosting factor setting signal BT, whereby the first charging state (see FIG. 7) of the pumping capacitors C1 and C2 and the first discharging state (see FIG. 8) of the pumping capacitors C1 and C2 are repeated. Thus, the charge pump circuit 102 outputs the output voltage VOUT obtained by multiplying the input voltage VIN by the voltage boosting factor of 2.

Specifically, referring to FIG. 7, at a first timing, the switches SW2, SW4, SW8 and SW9 are turned on and the other switches SW1, SW3, SW5, SW6, SW7, SW10 and SW11 are turned off (i.e., the first charging state). Thus, the two pumping capacitors C1 and C2 are connected in parallel between the VIN terminal and the GND terminal, and the two pumping capacitors C1 and C2 are charged with the input voltage VIN. As a result, the input voltage VIN appears between the terminals (i.e., between the terminals C1+ and C1−, and between the terminals C2+ and C2−) of the two pumping capacitors C1 and C2, respectively.

The control circuit 107 controls the regulator 106 to keep the output voltage VOUT of the charge pump circuit 102 constant. That is, in the first charging state, each of the two pumping capacitors C1 and C2 is charged with VIN=VOUT/2.

Referring to FIG. 8, at a second timing when a preset time period has lapsed after the first charging state, the switches SW1, SW3, SW5 and SW6 are turned on and the other switches SW2, SW4, SW7, SW8, SW9, SW10 and SW11 are turned off (i.e., the first discharging state). Thus, the two pumping capacitors C1 and C2 are connected in parallel between the VIN terminal and the VOUT terminal. As a result, the charge pump circuit 102 outputs the output voltage VOUT obtained by multiplying the input voltage VIN by the voltage boosting factor of 2.

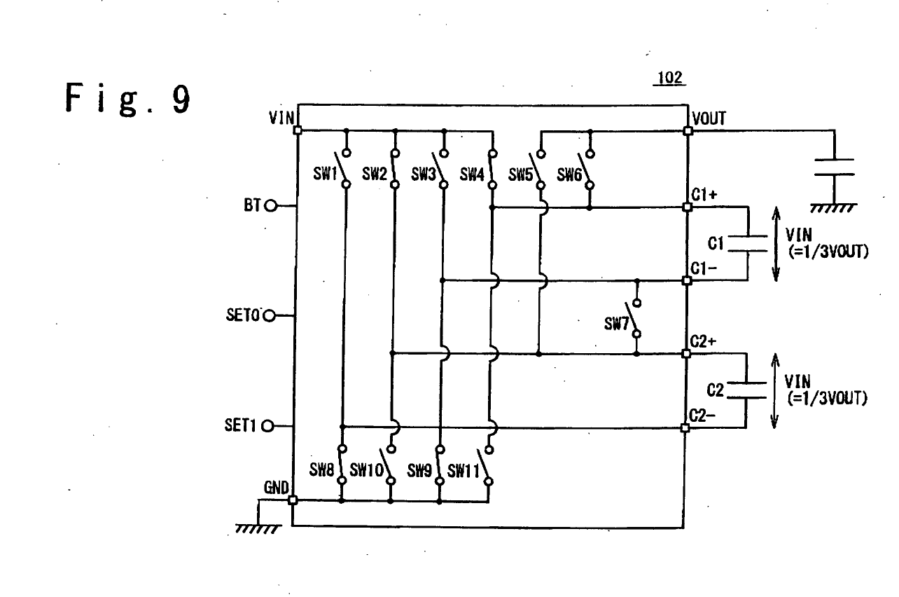

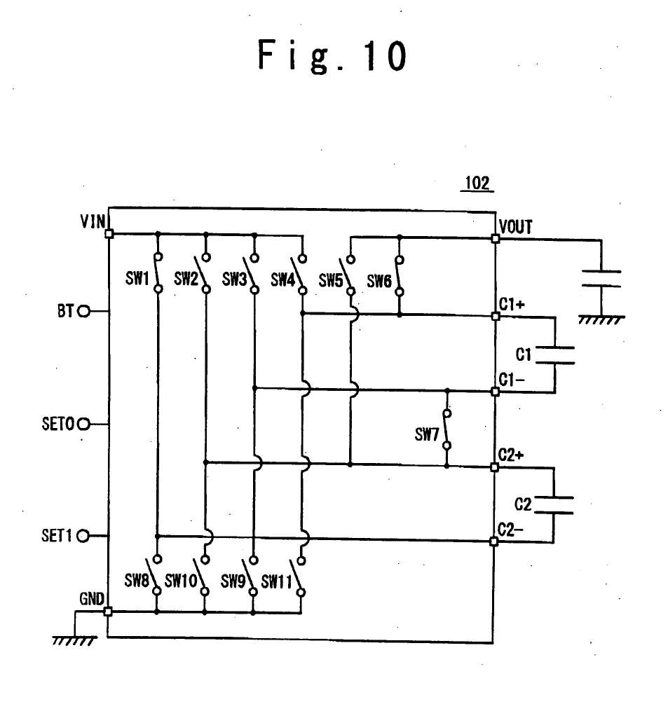

Further, when the input voltage VIN is multiplied by the voltage boosting factor of 3, the control of the switches SW1 to SW11 is executed based on the voltage boosting factor setting signal BT, whereby the second charging state (see FIG. 9) of the pumping capacitors C1 and C2 and the second discharging state (see FIG. 10) of the pumping capacitors C1 and C2 are repeated. Thus, the charge pump circuit 102 outputs the output voltage VOUT obtained by multiplying the input voltage VIN by the voltage boosting factor of 3.

Specifically, referring to FIG. 9, at a third timing, the switches SW2, SW4, SW8 and SW9 are turned on and the other switches SW1, SW3, SW5, SW6, SW7, SW10 and SW11 are turned off (i.e., the second charging state). Thus, the two pumping capacitors C1 and C2 are connected in parallel between the VIN terminal and the GND terminal, and the two pumping capacitors C1 and C2 are charged with the input voltage VIN. As a result, the input voltage VIN appears between the both terminals (i.e., between the terminals C1+ and C1−, and between the terminals C2+ and C2−) of the two pumping capacitors C1 and C2, respectively.

The control circuit 107 controls the regulator 106 to keep the output voltage VOUT of the charge pump circuit 102 constant. That is, in the second charging state, each of the two pumping capacitors C1 and C2 is charged with the voltage VIN=VOUT/3.

Referring to FIG. 10, at a fourth timing when a preset time period has lapsed after the second charging state, the switches SW1, SW6 and SW7 are turned on and the other switches SW2, SW3, SW4, SW5, SW8, SW9, SW10 and SW11 are turned off (i.e., the second discharging state). Thus, the two pumping capacitors C1 and C2 are connected in series between the VIN terminal and the VOUT terminal. As a result, the charge pump circuit 102 outputs the output voltage VOUT obtained by multiplying the input voltage VIN by the voltage boosting factor of 3.

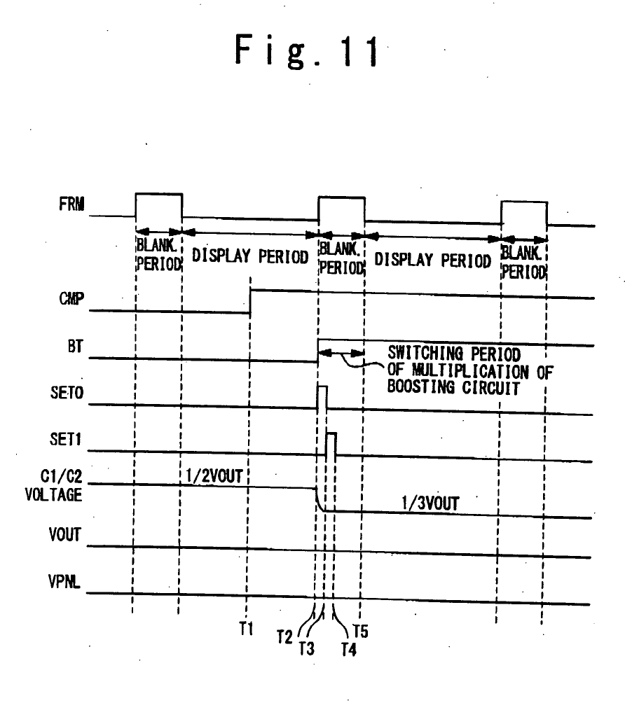

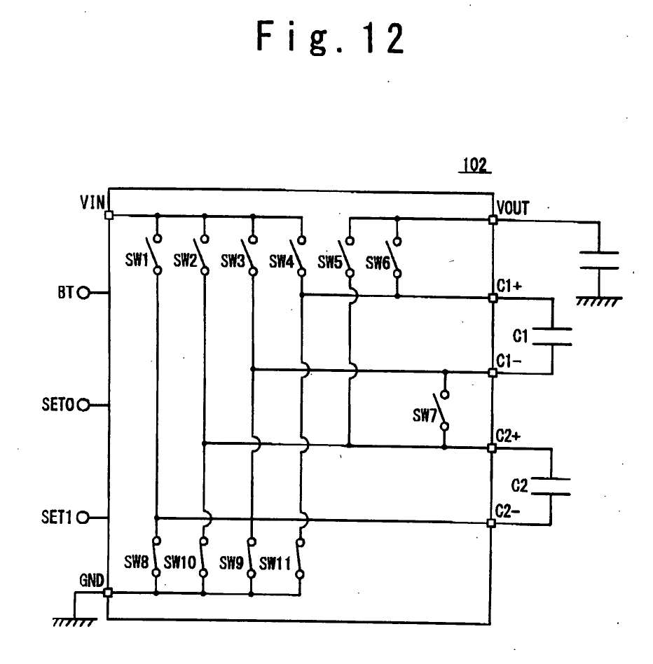

Next, an operation at a time of switching a voltage boosting factor will be described. The charge pump circuit 102 according to the present invention switches a voltage boosting factor for the output voltage VOUT in a non-display period in which the display panel is not driven, i.e., in a vertical blanking period or a horizontal blanking period. The switching operation from the multiplying operation by the voltage boosting factor of 2 to the multiplying operation by the voltage boosting factor of 3 according to the present invention will be described below referring to FIGS. 11 and 12.

In the power supply circuit 101, when the battery voltage VBAT falls down in a state of executing the multiplying operation by the voltage boosting factor of 2, the operation is switch to the multiplying operation by the voltage boosting factor of 3. FIG. 11 shows timing charts in the operation of the power supply circuit 101 for switching from the multiplying operation by the voltage boosting factor of 2 to the multiplying operation by the voltage boosting factor of 3.

Referring to FIG. 11, when the battery voltage VBAT falls down at a time T1, the comparing circuit 105 changes a signal level of the comparison result signal CMP. In this example, if the battery voltage VBAT is lowered below the reference voltage VREF3, the signal level of the comparison result signal CMP is changed from the low level to the high level. Thus, the control circuit 107 enters a switching waiting state to wait for a next blanking period, in accordance with a rising edge of the comparison result signal CMP.

The control circuit 107 in the switching waiting state outputs the preparation signals SET0 and SET1 and the voltage boosting factor setting signal BT representing the multiplying operation by the voltage boosting factor of 3 to the charge pump circuit 102 at the same time as the start of the blanking period in synchronization with the display frame signal FRM. More specifically, when the signal level of the frame signal FRM becomes high and the blanking period is started at a time T2 in the switching waiting state, the control circuit 107 changes the signal level of the voltage boosting factor setting signal BT from the low level indicative of the voltage boosting factor of 2 to the high level indicative of the voltage boosting factor of 3. At the same time, the control circuit 107 outputs the preparation signal SET0 in the high level during a preset period (during a time period from the time T2 to a time T3). The states of the switches SW1 to SW11 in the charge pump circuit 102 are changed in response to the rising edge of the voltage boosting factor setting signal BT, and the power supply circuit 101 is set to the third discharging state shown in FIG. 12 during the time period from the time T2 to the time T3 in which the preparation signal SET0 in the high level is supplied to the charge pump circuit 102.

Referring to FIG. 12, in response to the preparation signal SET0 in the high level, the switches SW8 to SW11 are turned on and the other switches SW1 to SW7 are turned off (in the third discharging state). Thus, the terminals of the two pumping capacitors C1 and C2 are connected and excessive charges stored in the pumping capacitors are discharged toward the ground. In this example, it is preferable to set the high level period (the time period from the time T2 to the time T3) of the preparation signal SET0, i.e., the period of the third discharging state in a manner such that the voltage of each of the pumping capacitors C1 and C2 is VOUT/3 or less. This period may be preset and may be changed under the control of the circuit which detects the voltage of the terminals C1+ and C2+.

At the time T3, the signal level of the preparation signal SET0 is changed to the low level and the signal level of the preparation signal SET1 is changed to the high level. The charge pump circuit 102 enters the second charging state shown in FIG. 9 in response to the rising edge of the preparation signal SET1 so that the pumping capacitors C1 and C2 are charged with the voltage VOUT/3. Then, the signal levels of the preparation signals SET0 and SET1 are both changed to the low level at a time T4, the charge pump circuit 102 enters the second discharging state shown in FIG. 10, and thereafter the charge pump circuit 102 starts the multiplying operation by the voltage boosting factor of 3 as mentioned above.

As described above, in the power supply circuit 101 for the display apparatus according to the present invention, the excessive charges of the two pumping capacitors C1 and C2 generated at the time of switching the voltage boosting factor to a higher side are discharged. That is, the pumping capacitors C1 and C2 are switched from a state charged with VIN=VOUT/2 to a state of charged with VIN=VOUT/3. Thus, according to the present invention, it is possible to prevent a backward current to the battery at the time of switching the voltage boosting factor to a higher side.

Further, in the power supply circuit 101 according to the present invention, the multiplying operation is started after the voltages of the two pumping capacitors are lowered to VOUT/3 or below. That is, the voltage difference of the pumping capacitors C1 and C2 before and after switching the voltage boosting factor is made equal to or an approximately equal to 0. Therefore, an incorrect 20° output voltage VOUT is prevented from being generated from the charge pump circuit 102. Thus, according to the present invention, an error in display due to a change of a voltage boosting factor can be prevented from occurrence.

Furthermore, it is preferable that the time T4 when the voltage boosting factor is switched is within the blanking period from the time T2 to time T5. By this arrangement, there can be further reduced an influence of the switching of the voltage boosting factor on the display operation.

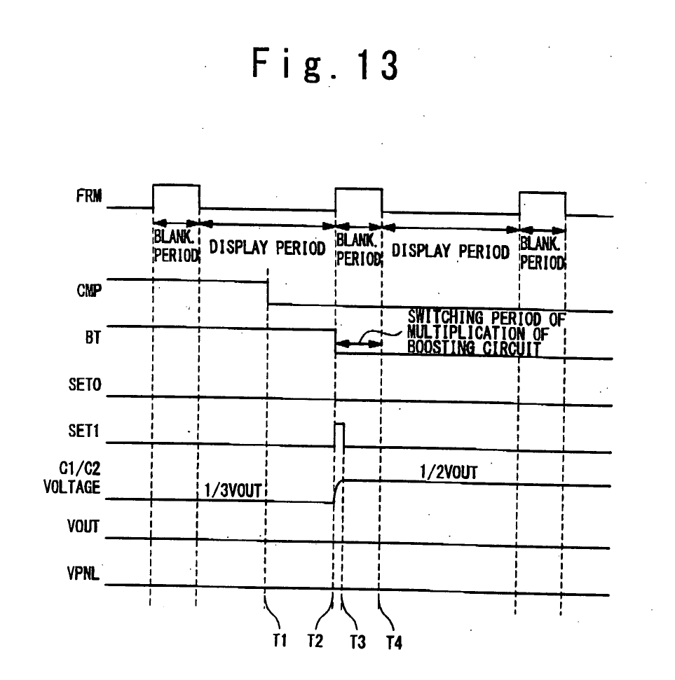

Next, an operation of switching the voltage boosting factor to a lower voltage side will be described. An operation of switching the voltage boosting factor of 3 to the voltage boosting factor of 2 according to the present invention will be described below referring to FIG. 13. In the power supply circuit 101, when the battery voltage VBAT is raised in a state of the multiplying operation by the voltage boosting factor of 3, the operation is switched to the multiplying operation by the voltage boosting factor of 2. FIG. 13 shows timing charts in the operation of the power supply circuit 101 at a time of switching from the multiplying operation by the voltage boosting factor of 3 to the multiplying operation by the voltage boosting factor of 2.

Referring to FIG. 13, when the battery voltage VBAT is raised at the time T1, the comparing circuit 105 changes a signal level of a comparison result signal CMP. Here, if the battery voltage VBAT is beyond the reference voltage VREF3, the signal level of the comparison result signal CMP is changed from the high level to the low level. The control circuit 107 enters a switching waiting state to wait for a next blanking period in response to a falling edge of the comparison result signal CMP.

The control circuit 107 entering the switching waiting state outputs the preparation signal SET1 and the voltage boosting factor setting signal BT representing the multiplying operation by the voltage boosting factor of 2 to the charge pump circuit 102 at the same time as start of the blanking period in synchronization with the display frame signal FRM. More specifically, when the signal level of the frame signal FRM is set to the high level and the blanking period is started at the time T2 in the switching waiting state, the control circuit 107 changes the signal level of the voltage boosting factor setting signal BT from the high level indicative of the voltage boosting factor of 3 to the low level indicative of the voltage boosting factor of 2. At the same time, the control circuit 107 outputs the preparation signal SET1 in the high level during a preset period (during the time period from the time T2 to the time T3). The switching states of the switches SW1 to SW11 in the charge pump circuit 102 are switched in response to the falling edge of the voltage boosting factor setting signal BT, and the operation state is changed to the first charging state shown in FIG. 7 during the time period from the time T2 to the time T3 in which the preparation signal SET1 of the high level is supplied to the charge pump circuit 102. That is, the same switching control is executed as that in the first charging state at a time of executing the multiplying operation by the voltage boosting factor of 2 within a preset period of the blanking period so that the pumping capacitors C1 and C2 are charged with VOUT/2.

Then, the signal levels of the preparation signals SET0 and SET1 are both changed to the low level at the time T3, the operation enters the first discharging state shown in FIG. 8, and thereafter the charge pump circuit 102 starts the multiplying operation by the voltage boosting factor of 2 as mentioned above.

As described above, in the power supply circuit 101 according to the present invention, the switching of the voltage boosting factor is started after the voltages of the pumping capacitors C1 and C2 are changed to VOUT/2. Therefore, the voltage boosting factor can be switched to the lower voltage side without reducing the output voltage VOUT of the charge pump circuit 102. Furthermore, it is preferable that the time T3 when the voltage boosting factor is switched is in the blanking period from the time T2 to the time T4. By this arrangement, there can be further reduced an influence of the change of the voltage boosting factor on the display operation.

In the power supply circuit 101 according to the present invention, when the excessive charges are generated, the voltage boosting factor is switched after the excessive charges are discharged. Also, when the output voltage is lowered, the voltage boosting factor is switched after the pumping capacitors are charged to a required voltage. By this arrangement, a backward current to the battery and an erroneous output voltage can be prevented from being generated from the charge pump circuit 102. Moreover, the switching of the voltage boosting factor is executed in a “non-display period” during which display apparatus driving is not performed (for example, in a blanking period), and therefore, an degradation of display quality can be prevented.

Although the present invention has been described in connection with the embodiments, various changes and modifications will be apparent to those skilled in the art. It should be noted that such changes and modifications are included within the scope of the present invention. According to the present embodiment, although the voltage boosting factors of 2 and 3 have been described as examples, the present invention is not limited to these examples and any other voltage boosting factor can be used. In this case, the switching configuration and the voltage boosting operation are, of course, adjusted to the voltage boosting factor.

What is claimed is:

1. A power supply circuit for a display apparatus, comprising:
a voltage boosting circuit configured to boost up an input voltage based on a voltage boosting factor to output a boosted output voltage;
a voltage detecting circuit configured to compare a voltage level of a power supply voltage to which the input voltage is related and a predetermined voltage level; and
a control circuit configured to output one of a first voltage boosting factor and a second voltage boosting factor as the voltage boosting factor to said voltage boosting circuit based on the comparison result,
wherein said control circuit changes the voltage boosting factor during a blanking period in a display panel.

2. The power supply circuit according to claim 1, wherein said control circuit outputs the first voltage boosting factor to said voltage boosting circuit, when the voltage level of the input voltage is equal to or higher than the predetermined voltage level, and
wherein said voltage boosting circuit discharges a part of charges stored in pumping capacitors in response to the first voltage boosting factor, and then boosts up the input voltage in response to the first voltage boosting factor to generate the boosted output voltage.

3. The power supply circuit according to claim 1, wherein said control circuit outputs the second voltage boosting factor to said voltage boosting circuit (102), when the voltage level of the input voltage is lower than the predetermined voltage level, and
wherein said voltage boosting circuit charges pumping capacitors in response to the second voltage boosting factor, and then boosts up the input voltage in response to the second voltage boosting factor to generate the boosted output voltage.

4. The power supply circuit according to claim 1, wherein said control circuit changes the voltage boosting factor in response to a frame signal which is used to control the blanking period.

5. The power supply circuit according to claim 3, further comprising:
a regulator configured to generate the input voltage from the power supply voltage.

6. The power supply circuit according to claim 5, wherein the power supply voltage is directly supplied from a battery.

7. A voltage boosting method for a display apparatus, comprising:
comparing a voltage level of a power supply voltage and a predetermined voltage level;
generating one of a first voltage boosting factor and a second voltage boosting factor as a voltage boosting factor based on the comparison result during a blanking period in a display panel; and
boosting up an input voltage related to the power supply voltage in response to the voltage boosting factor to output a boosted output voltage.

8. The voltage boosting method according to claim 7, wherein said generating comprises:
generating the first voltage boosting factor when the voltage level of the input voltage is equal to or higher than the predetermined voltage level, and
said boosting comprises:
discharging a part of charges stored in pumping capacitors in response to the first voltage boosting factor; and
boosting up the input voltage in response to the first voltage boosting factor to generate the boosted output voltage, after the discharging.

9. The voltage boosting method according to claim 7, wherein said generating comprises:
generating the second voltage boosting factor when the voltage level of the input voltage is lower than the predetermined voltage level, and
said boosting comprises:
charging pumping capacitors in response to the second voltage boosting factor; and
boosting up the input voltage in response to the second voltage boosting factor to generate the boosted output voltage, after the charging.

10. The voltage boosting method according to claim 7, wherein said generating comprises:
generating the voltage boosting factor in response to a frame signal which is used to control the blanking period.

11. A display apparatus comprising:
a display panel; and
a power supply circuit,
wherein said power supply circuit comprises:
a voltage boosting circuit configured to boost up an input voltage based on a voltage boosting factor to output a boosted output voltage;
a voltage detecting circuit configured to compare a voltage level of a power supply voltage to which the input voltage is related and a predetermined voltage level; and
a control circuit configured to output one of a first voltage boosting factor and a second voltage boosting factor as the voltage boosting factor to said voltage boosting circuit based on the comparison result,
wherein said control circuit changes the voltage boosting factor during a blanking period in said display panel.

12. The display apparatus according to claim 11, wherein said control circuit outputs the first voltage boosting factor to said voltage boosting circuit, when the voltage level of the input voltage is equal to or higher than the predetermined voltage level, and
wherein said voltage boosting circuit discharges a part of charges stored in pumping capacitors in response to the first voltage boosting factor, and then boosts up the input voltage in response to the first voltage boosting factor to generate the boosted output voltage.

13. The display apparatus according to claim 11, wherein said control circuit outputs the second voltage boosting factor to said voltage boosting circuit, when the voltage level of the input voltage lower than the predetermined voltage level, and
wherein said voltage boosting circuit charges pumping capacitors in response to the second voltage boosting factor, and then boosts up the input voltage in response to the second voltage boosting factor to generate the boosted output voltage.

14. The display apparatus according to claim 11, wherein said control circuit changes the voltage boosting factor in response to a frame signal which is used to control the blanking period.

15. The display apparatus according to claim 13, wherein said power supply circuit further comprises:
a regulator configured to generate the input voltage from the power supply voltage.

16. The display apparatus according to claim 15, wherein the power supply voltage is directly supplied from a battery.
